(19) United States
(12) Patent Application Publication
(10) Pub. No.: US 2010/0080472 A1
(43) Pub. Date: Apr. 1, 2010

(54) IMAGE PROCESSING APPARATUS, MOVING IMAGE DECODING APPARATUS, MOVING IMAGE ENCODING APPARATUS AND METHOD

(75) Inventor: Wataru Asano, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/564,280

(22) Filed: Sep. 22, 2009

(30) Foreign Application Priority Data
Sep. 26, 2008 (JP) 2008-248452

(51) Int. Cl. G06K 9/40; G06K 9/46; G06K 9/36

(52) U.S. Cl. 382/233; 382/260; 382/251; 382/238; 382/248

(57) ABSTRACT

An image processing apparatus includes a size acquiring unit that acquires a block size of an orthogonal transformation from encoded data of an image compressed by performing the orthogonal transformation and quantization for each block; a filter selecting unit that selects a filter for each block, the filter reducing an encoding distortion from each block of a decoded image; and an encoding-distortion reducing unit that reduces an encoding distortion by the filter on all pixels within the block. The filter selecting unit selects the filter so that a strength of the filter strengthens by increasing of the block size, or selects the filter so that the number of taps of the filter decreases by reduction of the block size.

### CROSS-REFERENCE TO RELATED APPLICATIONS

This application is based upon and claims the benefit of priority from the prior Japanese Patent Application No. 2008-248452, filed on Sep. 26, 2008; the entire contents of which are incorporated herein by reference.

### BACKGROUND OF THE INVENTION

1. Field of the Invention

The present invention relates to an image processing apparatus, a moving image decoding apparatus, a moving image encoding apparatus and method.

2. Description of the Related Art

Conventionally, there is a method of removing a distortion occurring in a decoded image when encoding a moving image by an encoding method including an orthogonal transformation and quantization. Examples of the distortion occurring in the decoded image include block noise, ringing noise, and mosquito noise. Ringing noise is a waveform distortion occurring at an edge periphery of an object or the like included in an image, and it occurs as a result of deleting a high frequency component of a conversion coefficient by quantization after an orthogonal transformation during encoding. The ringing noise and the mosquito noise may not be clearly distinguished.

In an image decoding apparatus disclosed in JP-A 2003-18600 (KOKAI), by a quantization scale in image encoding of a moving picture experts group (MPEG) standard, two filters are switched to decrease block noise or mosquito noise, thereby improving the quality of the decoded image.

Ringing noise is generated when an edge is included in a block in which an orthogonal transformation is performed, and when a filtering process for removing the distortion is performed in a block in which no ringing noise is generated, an image quality change such as a blurred object included in the image can be generated. Thus, from the decoded image in which the presence of noise differs in each block, the noise can be favorably removed by employing a parameter included in encoded data. However, in the image decoding apparatus described in JP-A 2003-18600 (KOKAI), such an issue is not taken into consideration.

### SUMMARY OF THE INVENTION

According to one aspect of the present invention, an image processing apparatus includes a size acquiring unit that acquires a block size of an orthogonal transformation from encoded data of an image compressed by performing the orthogonal transformation and quantization for each block; a filter selecting unit that selects a filter for each block, the filter reducing an encoding distortion from each block of a decoded image; and an encoding-distortion reducing unit that reduces an encoding distortion by the filter on all pixels within the block, wherein the filter selecting unit selects the filter so that a strength of the filter strengthens by increasing of the block size, or selects the filter so that the number of taps of the filter decreases by reduction of the block size.

According to another aspect of the present invention, a moving image decoding apparatus that decodes encoded data encoded by a compressing process including an inter-picture predicting process, and an orthogonal transformation and a quantizing process performed for each block in which the picture is divided, for moving image data constituted by a plurality of continuous pictures, thereby generating a decoded moving image, the apparatus includes a size acquiring unit that acquires a block size for each of the block in the decoded picture; a filter selecting unit that selects a filter for each block, the filter reducing an encoding distortion from each block of a decoded image; an encoding-distortion reducing unit that reduces an encoding-distortion by the filter, on all pixels in the block; and a decoding unit that decodes, from the encoded data, the picture encoded by the inter-picture predicting process by using, as a reference picture, the picture on which the encoding-distortion is reduced, wherein the filter selecting unit selects the filter so that a strength of the filter strengthens by increasing of the block size, or selects the filter so that the number of taps of the filter decreases by reduction of the block size.

According to still another aspect of the present invention, a moving image encoding apparatus that performs, on moving image data constituted by a plurality of continuous pictures, a compressing process including an inter-picture predicting process, and an orthogonal transformation and a quantizing process performed for each block in which the pictures are divided, thereby generating encoded data, the apparatus includes a partial-image decoding unit that decodes a partial image by performing an inverse quantizing process and an inverse orthogonal transformation on a picture on which the orthogonal transformation and the quantizing process are performed; a size acquiring unit that acquires a block size for each block in the partial image decoded; a filter selecting unit that selects a filter for each block, the filter reducing an encoding distortion from each block of a decoded image; and an encoding-distortion reducing unit that reduces an encoding-distortion by the filter, on all pixels in the block, wherein the partial-image decoding unit further uses, as a reference image, a partial image on which the encoding-distortion is reduced, thereby decoding the partial image of the picture on which the inter-picture predicting process is performed, the filter selecting unit selects the filter so that a strength of the filter strengthens by increasing of the block size, or selects the filter so that the number of taps of the filter decreases by reduction of the block size.

### BRIEF DESCRIPTION OF THE DRAWINGS

FIG. 1 is a block diagram illustrating a configuration example of an image processing apparatus;

FIG. 2 is a block diagram illustrating another configuration example of the image processing apparatus;

FIG. 3 is a schematic diagram for explaining a relation between an edge region and a filtering process;

FIG. 4 is a block diagram illustrating still another configuration example of the image processing apparatus;

FIG. 5 is a flowchart of a filter selecting process based on a size of a block of an orthogonal transformation;

FIG. 6 is a diagram for expressing pixel values of a block in which an orthogonal transformation and a quantizing process are performed;

FIG. 7 is a flowchart of a filter selecting process based on whether an edge region is included in a block;

FIG. 8 is a flowchart of a filter selecting process based on a quantization step size for respective blocks;

FIG. 9 is a schematic diagram for explaining an example of a loop filter incorporated in a moving image decoding apparatus; and

FIG. 10 is a schematic diagram for explaining an example of a loop filter incorporated in a moving image encoding apparatus.

### DETAILED DESCRIPTION OF THE INVENTION

Exemplary embodiments of the present invention will be explained below in detail with reference to the accompanying drawings. In the following embodiment, “bit stream” is also called “code string”. For example, in the following embodiment, noise that is generated when decoding encoded data encoded by an encoding method, which includes an orthogonal transformation and quantization such as H.264 (MPEG-4 AVC), is removed.

In H.264, unlike other encoding methods such as MPEG-2, a block size for the orthogonal transformation has two types, namely 4×4 and 8×8. Among various types of noise, a ringing noise, for example, is generated inside a block in which the orthogonal transformation is performed. When the block size of the orthogonal transformation is small, the ringing noise is not as conspicuous as a case that the block size is large. In the following embodiment, block size information included in encoded data is used, and thus noise removal is favorably performed.

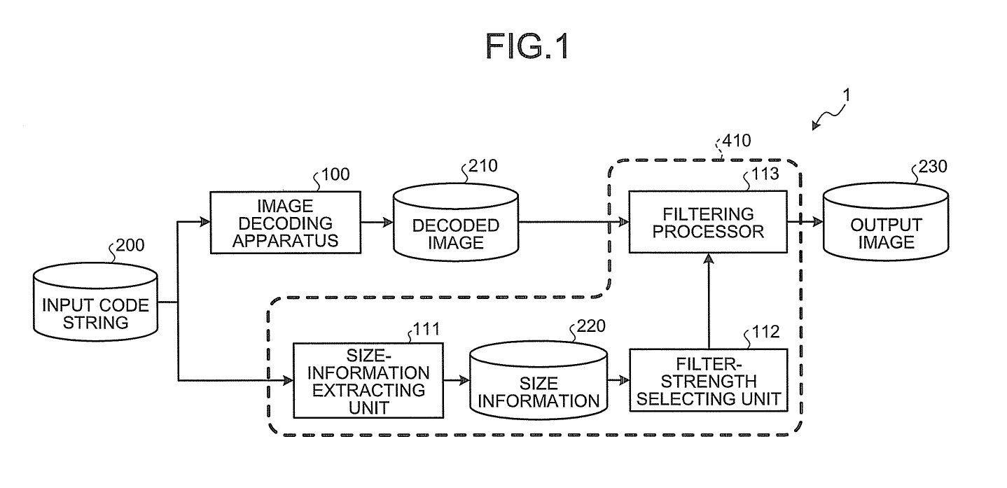

An image processing apparatus 1 of FIG. 1 includes a filter apparatus 410 and an image decoding apparatus 100. The filter apparatus 410 acquires information of a block size of an orthogonal transformation from an input code string 200 that is inputted, and based on the information of the block size, a filtering process for removing noise from a decoded image is performed.

The image decoding apparatus 100 decodes the input code string 200, which is encoded moving image information, to generate a decoded image 210.

The filter apparatus 410 includes a size-information extracting unit 111, a filter-strength selecting unit 112, and a filtering processor 113. The size-information extracting unit 111 extracts size information 220 of the block in the orthogonal transformation used during encoding, from the input code string 200.

The filter-strength selecting unit 112 selects whether to perform a filtering process for removing noise, or the strength of a filter, the number of taps or the like for each block, based on the size information 220. More particularly, a block in which the strength of a filter is more strengthened is larger or the same in block size, than or as a block in which the strength of a filter is weaker than that block. Another example is that a block in which the number of taps for the filter is more increased is larger or the same in block size, than or as a block in which the number of taps for the filter is smaller than that block. Another example is that the number of taps of a filter for a block decreases by reduction of block size of the block. Another example is that a strength of the filter for a block strengthens by increasing of the block size of the block.

The filtering processor 113 performs a filtering process according to the strength of a filter, the number of taps or the like selected by the filter-strength selecting unit 112, on the decoded image 210, and outputs an output image 230. When not performing the filtering process is selected in the filter-strength selecting unit 112, the filtering processor 113 does not perform the filtering process on the decoded image 210.

In the present embodiment, the size-information extracting unit 111 can be arranged outside the filter apparatus 410. For example, when the size-information extracting unit 111 is arranged inside the image decoding apparatus 100, the filter apparatus 410 receives the size information 220 from the image decoding apparatus 100.

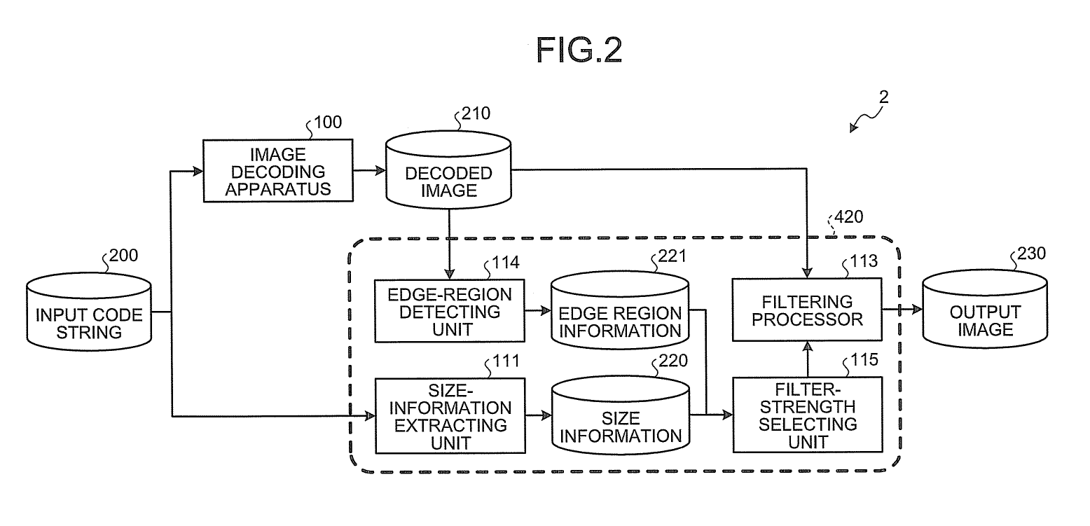

FIG. 2 is a block diagram illustrating an example of an image processing apparatus according to the embodiment, the image processing apparatus being different from that shown in FIG. 1. More particularly, FIG. 2 is a schematic diagram for explaining a functional configuration of an image processing apparatus that performs a process based on information of an edge region within a decoded image.

An image processing apparatus 2 of FIG. 2 includes a filter apparatus 420 and the image decoding apparatus 100. The image decoding apparatus 100 decodes the input code string 200, which is encoded moving image information, to generate the decoded image 210. The generated decoded image is processed by the filter apparatus 420 for each picture.

The filter apparatus 420 includes the size-information extracting unit 111, a filter-strength selecting unit 115, the filtering processor 113, and an edge-region detecting unit 114. In the filter apparatus 420, in a block having the same functions and configuration as those in the filter apparatus 410 shown in FIG. 1, like reference numerals are denoted as those shown in FIG. 1, and descriptions thereof will be omitted.

The edge-region detecting unit 114 detects edge region information 221 from the decoded image 210. The edge region information 221 is information of an edge region of an object in which the decoded image is included, for example.

The filter-strength selecting unit 115 selects whether to perform a filtering process for removing noise, or the strength of a filter, the number of taps or the like for each block, based on the size information 220 and the edge region information 221. More particularly, for a block not including the edge region, not performing the filtering process is selected. For a block including the edge region, the strength of a filter, the number of taps or the like are selected in a similar manner to the filter-strength selecting unit 112 shown in FIG. 1.

According to the configuration of FIG. 2, out of the blocks in which the orthogonal transformation is performed, the filtering process for removing noise is performed only on the block including the edge region. On the block not including the edge region, the filtering process is not performed. Therefore, it is possible to decrease the influence on the image caused by the filtering process.

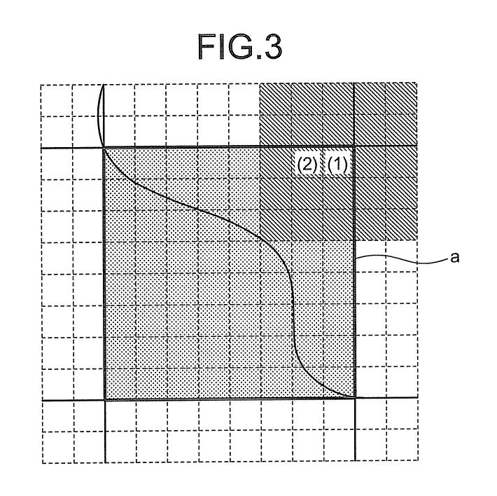

In FIG. 3, one section surrounded by a dotted line represents one pixel, and a block “a” by a solid line represents a block in which the orthogonal transformation is performed. A curve by a solid line represents an edge position of the object. In FIG. 3, the curve is written within the pixel, and in the present embodiment, a pixel including the curve is a pixel at the edge position of the object.

In this case, the block “a” includes the edge, and thus the filtering processor 113 performs the filtering process on all the pixels included in the block “a”. More particularly, when performing the filtering process on a pixel (1), for example, a filtering process of 5×5 taps employing diagonally hatched vertical and horizontal five pixels (hereinafter, “5×5 pixels”) is performed. In a filtering process on a pixel (2) immediately to the left of the pixel (1), 5×5 pixels shifted by one pixel to the left from the 5×5 pixels used for the filtering process on the pixel (1) are used.

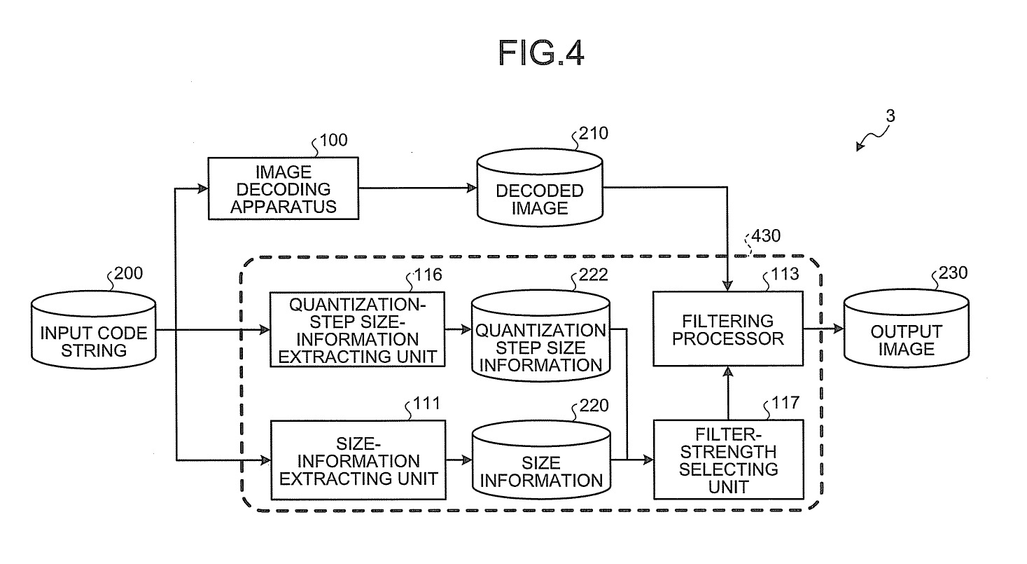

FIG. 4 is a block diagram illustrating an example of an image processing apparatus according to the embodiment, the image processing apparatus being different from those shown in FIG. 1 and FIG. 2. More particularly, FIG. 4 is a schematic diagram for explaining a functional configuration of an image processing apparatus that performs a process based on information of a quantization step size within the input code string.

An image processing apparatus 3 of FIG. 4 includes a filter apparatus 430 and the image decoding apparatus 100. The image decoding apparatus 100 decodes the input code string 200, which is encoded moving image information, to generate the decoded image 210.

The filter apparatus 430 includes the size-information extracting unit 111, a filter-strength selecting unit 117, the filtering processor 113, and a quantization-step size-information extracting unit 116. In the filter apparatus 430, in a block having the same functions and configuration as those in the filter apparatus 410 shown in FIG. 1, like reference numerals are denoted as those shown in FIG. 1, and descriptions thereof will be omitted.

The quantization-step size-information extracting unit 116 extracts quantization step size information 222, which is information of a quantization step size used during encoding, from the input code string 200. More particularly, when the input code string is decoded, for example, information of the quantization step size corresponding to each block in which the orthogonal transformation is performed is decoded to acquire the quantization step size information 222.

The filter-strength selecting unit 117 selects whether to perform a filtering process for removing noise, or the strength of a filter, the number of taps or the like for each block, based on the size information 220 and the quantization step size information 222. More particularly, a block in which the strength of a filter is more strengthened is larger or the same in quantization step size, than or as a block in which the strength of a filter is weaker than that block. In another example, a block in which the number of taps for the filter is more increased is larger or the same in quantization step size, than or as a block in which the number of taps for the filter is smaller than that block.

The filtering processor 113 performs a filtering process according to the strength of a filter, the number of taps or the like selected by the filter-strength selecting unit 112, on the decoded image 210, and outputs the output image 230. When not performing the filtering process is selected in the filter-strength selecting unit 117, the filtering processor 113 does not perform the filtering process on the decoded image 210.

According to the configuration of FIG. 3, the filtering process for removing noise, which is based on the quantization step size, is performed for each block in which the orthogonal transformation is performed, and thus the noise removal for the block in which noise is generated is effectively performed. On a block in which only a small amount of noise is generated, no filtering process is performed, and thus the influence on the image by the filtering process can be decreased.

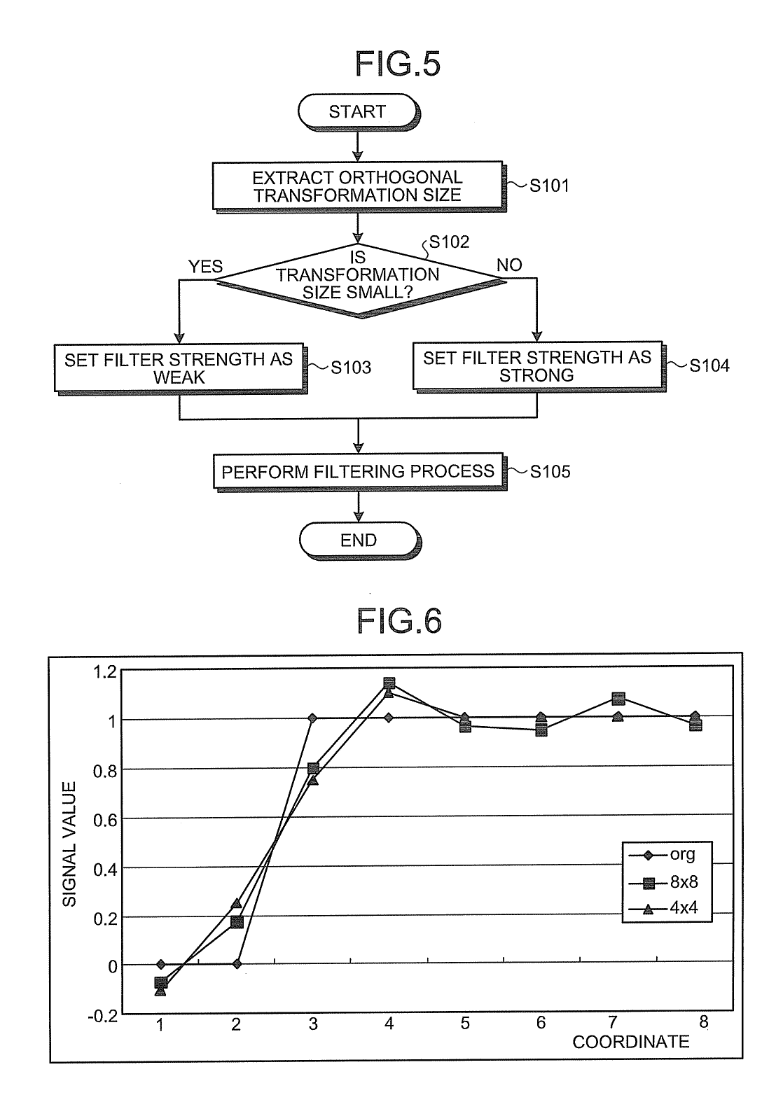

FIG. 5 is a flowchart for explaining performing of a filtering process based on the size of a block for each block in which the orthogonal transformation is performed during encoding. The process shown in FIG. 5 is performed by the filter apparatus 410 of FIG. 1, for example.

At Step S101 shown in FIG. 5, the size-information extracting unit 111 extracts the size information of the block of the orthogonal transformation performed during encoding, from the input code string 200, and outputs the size information 220. More particularly, in a case of H.264, for example, the size of the block of the orthogonal transformation is permitted to differ for each macro block, and a value is included in transform_size_{—}8×8_flag which is one of syntax elements of the input code string. That is, in H.264, if the transform_size_{—}8×8_flag is “0”, the size is 4×4, and if it is “1”, the size is 8×8.

Subsequent to Step S101, the process proceeds to Step S102 at which the filter-strength selecting unit 112 refers to the size information 220 to check, for each pixel that is a target for the filtering process, whether the pixel belongs to the block of the orthogonal transformation of a smaller size in the orthogonal transformation during encoding. When the pixel belongs to the block of the orthogonal transformation of a smaller size, the process proceeds to Step S103. Otherwise, the process proceeds to Step S104. That is, in an example of H.264, for example, a 4×4 orthogonal transformation is the block of an orthogonal transformation of a small size, and an 8×8 orthogonal transformation is an orthogonal transformation of a large size.

At Step S103 subsequent to Step S102, the filter-strength selecting unit 112 sets at least one of invalidating the filtering process on the pixel targeted for the determination at Step S102, weakening the strength of a filter on that pixel, and lessening the number of taps for the filter. More particularly, when setting the strength of a filter, if the filter is a low-pass filter, for example, a filter having a wider passband width is selected, and if the filer is an ε-filter, a threshold value is reduced. For the number of taps, 3×3 taps or the like are used, for example.

Meanwhile, at Step S104 subsequent to Step S102, the filter-strength selecting unit 112 sets at least one of strengthening the strength of a filter, and increasing the number of taps for the filter. More particularly, when setting the strength of a filter, if the filter is a low-pass filter, a filter having a narrower passband is selected, and if the filter is an ε-filter, a threshold value is increased. For the number of taps, 5×5 taps or the like are used, for example.

Subsequent to Step S103 or Step S104, the process proceeds to Step S105 at which the filtering processor 113 performs the filtering process for removing an encoding distortion by employing the filter selected at Step S103 or Step S104, on the decoded image 210.

By the process shown in FIG. 5, a strong filtering process for removing an encoding distortion can be performed on a pixel that is tended to have a conspicuous encoding distortion and that belongs to the block in which the size of the orthogonal transformation is large. Moreover, for other pixels, an increase in blurred image feeling caused by the filtering process can be prevented.

In an example shown in FIG. 5, the strength of a filter or the like is divided into two stages based on the size of the orthogonal transformation. However, the present embodiment not limited to the example shown in FIG. 5, and the strength of a filter or the like can be divided into three or more stages when there are three or more types of sizes of the orthogonal transformation.

FIG. 6 is a diagram for expressing pixel values of a decoded image obtained by decoded image data that is encoded as a result of performing the orthogonal transformation and the quantizing process. FIG. 6 depicts signal values obtained by cutting a pixel along an axis in one direction, out of a two-dimensional image. The horizontal axis represents a one-dimensional coordinate of the pixel and the vertical axis represents a signal value of the pixel. “org” represents alignment of pixels including the edge. A coordinate 2 and a coordinate 3 correspond to an edge portion.

Values of “4×4” and “8×8” are obtained by performing a discrete cosine transform (DCT), which is one of orthogonal transformations, with the respective sizes of 4×4 and 8×8, and then performing an inverse discrete cosine transform (IDCT) after performing one mode of quantization in which a high-pass component is rounded down to 0.

The 8×8 orthogonal transformation is performed by employing pixels from a coordinate 1 to the coordinate 8. In the 4×4 orthogonal transformation, two orthogonal transformations are performed, that is, a transformation employing the pixels from the coordinate 1 to the coordinate 4, and a transformation employing the pixels from a coordinate 5 to the coordinate 8.

In FIG. 6, with respect to the values of 8×8 having a larger orthogonal transformation size, the distortion caused by encoding appears across the pixels from the coordinate 1 to the coordinate 8. That is, the distortion is spread across a wide range, and thus the distortion is visually conspicuous. On the other hand, with respect to the values of 4×4 having a smaller orthogonal transformation size, the distortion does not appear in the pixels from the coordinate 5 to the coordinate 8. Regarding the pixels from the coordinate 1 to the coordinate 4, because of proximity to the edge, the distortion is not conspicuous.

Accordingly, to accurately remove the encoding distortion, the filtering process for removing the encoding distortion can be performed at locations where the size of the orthogonal transformation is large. The filter through which the encoding distortion is removed removes the distortion while generating a blurred image, because it erases fine image textures. To solve this problem, at location where the transformation size of the orthogonal transformation is small, the filtering process for removing the encoding distortion is not performed, or a filter in which the strength of a filter is weak or a filter in which number of taps is small can be used.

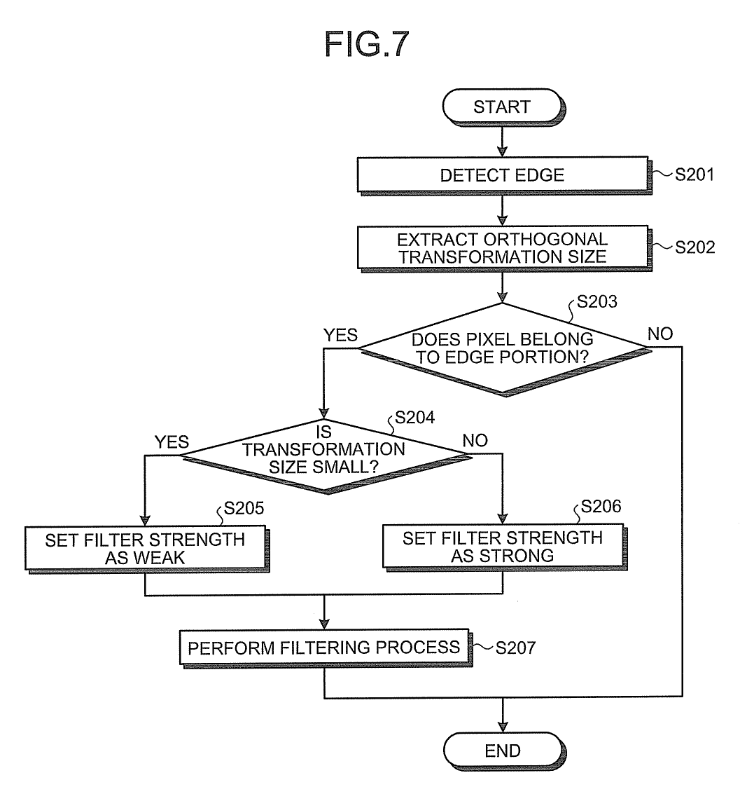

FIG. 7 is a flowchart for explaining switching of filtering processes based on whether the edge region is included in a block, for each block in which the orthogonal transformation is performed during encoding. The process shown in FIG. 7 is performed by the filter apparatus 420 of FIG. 2, for example.

At Step S201 shown in FIG. 7, the edge-region detecting unit 114 detects the edge region from the decoded image 210, and outputs the edge region information 221. The method of detecting the edge region can be selected from a method in which a sobel filter is used, a method in which distribution of pixel values in a small region is used, and the like. Subsequent to Step S201, the process proceeds to Step S202 at which the size-information extracting unit 111 extracts the information of the block size of the orthogonal transformation from the input code string 200, and outputs the size information 220.

Subsequent to Step S202, the process proceeds to Step S203 at which the filter-strength selecting unit 112 refers to the edge region information 221 to check whether the pixel targeted for the filtering process belongs to the edge region. More particularly, when there is included the edge within the orthogonal transformation block including the target pixel, it is interpreted that the pixel is included in the edge region. For example, in the alignment of pixels “org” shown in FIG. 6, when the size of the orthogonal transformation is 4×4, the pixels from the coordinate 1 to a coordinate 4 belong to the edge region, and those from the coordinates 5 to 8 do not belong to the edge region. On the other hand, when the size of the orthogonal transformation is 8×8, all the pixels from the coordinate 1 to the coordinate 8 belong to the edge region.

When the pixel is included in the edge region, the process proceeds to Step S204, and when the pixel is not included in the edge region, the process is ended.

At Step S204 subsequent to Step S203, by referring to the size information 220, the pixel targeted for the filtering process is checked as to whether that pixel is processed by the orthogonal transformation of a smaller size. When the pixel is processed by the orthogonal transformation of a smaller size, the process proceeds to Step S205. Otherwise, the process proceeds to Step S206.

At Step S205 subsequent to Step S204, the filter-strength selecting unit 115 sets at least one of invalidating the filter for the pixel, weakening the strength of a filter, and lessening the number of taps for the filter.

Meanwhile, at Step S206 subsequent to Step S204, the filter-strength selecting unit 115 sets at least one of strengthening the strength of a filter for the pixel, and increasing the number of taps for the filter.

At Step S207 subsequent to Step S205 or Step S206, the filtering processor 113 performs the filtering process for removing the encoding distortion on the decoded image 210 by employing the filter selected at Step S205 or Step S206.

In the example shown in FIG. 7, the order of the process at Step S201 at which the edge region is detected and the process at Step S202 at which the block size of the orthogonal transformation is extracted can be reversed.

By the process shown in FIG. 7, at locations including edges tended to have a conspicuous ringing noise can be subjected to a filter for removing a ringing noise, and thus effective noise removal can be performed. By not performing the filtering process or performing a weak filtering process at locations not including the edge, an increase in blurred image feeling caused by the filtering process can be prevented.

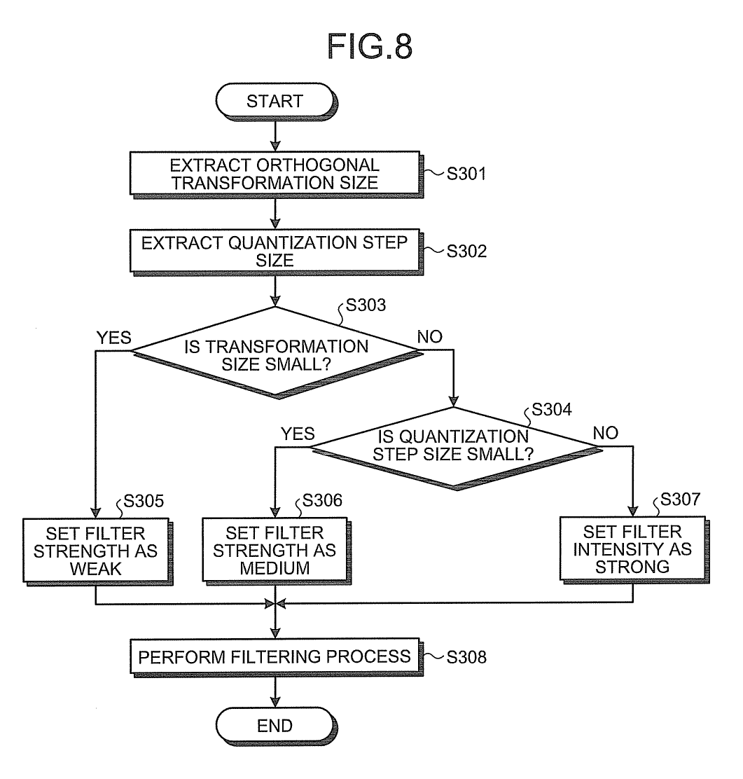

FIG. 8 is a flowchart for explaining a switching process of the filtering process based on the quantization step size for a block, for each block in which the orthogonal transformation is performed during encoding. The process shown in FIG. 8 is performed by the filter apparatus 430 of FIG. 4, for example.

At Step S301 shown in FIG. 8, the size-information extracting unit 111 extracts the information of the block size of the orthogonal transformation used during encoding, from the input code string 200, and outputs the size information 220. Subsequent to Step S301, the process proceeds to Step S302 at which the quantization-step size-information extracting unit 116 extracts from the input code string 200 the information of the quantization step size for the block during encoding, and outputs the quantization step size information 222.

Subsequent to Step S302, the process proceeds to Step S303 at which the filter-strength selecting unit 112 refers to the size information 220 to check as to whether the pixel targeted for the filtering process is processed by the orthogonal transformation of a small size. When the size of the orthogonal transformation is small, the process proceeds to Step S305. Otherwise, the process proceeds to Step S304.

At Step S305 subsequent to Step S303, the filter-strength selecting unit 117 sets at least one of invalidating the filtering process on the pixel, weakening the strength of a filter of the filtering process for that pixel, and lessening the number of taps for the filter of the filtering process for that pixel.

Meanwhile, at Step S304 subsequent to Step S303, the filter-strength selecting unit 117 refers the quantization step size information 222 to check in what quantization step step sizes the pixel targeted for the filtering process is quantized during encoding. More particularly, whether the quantization step size is smaller than a predetermined value can be checked, for example. When the quantization step size is small, the process proceeds to Step S306. Otherwise, the process proceeds to Step S307.

At Step S307 subsequent to Step S304, the pixel targeted for the filtering process tends to have a large encoding distortion by the quantization, and thus at least one of strengthening the strength of a filter and increasing the number of taps for the filter is set.

Meanwhile, at Step S306 subsequent to Step S304, the pixel targeted for the filtering process tends to have a small encoding distortion by the quantization, and thus the strength of a filter, the number of taps or the like are set equal to or more than the value set forth at Step S305 and equal to or less than the value set forth at Step S307.

At Step S308 subsequent to Steps S305, S306, or S307, the filtering processor 113 performs the filtering process for removing the encoding distortion on the decoded image 210 by employing the filters selected at Step S305, Step S306, and Step S307.

By the process shown in FIG. 8, at locations where the quantization step size tended to have a conspicuous encoding distortion is large and the size of the orthogonal transformation is large, a strong filter for removing an encoding distortion can be applied. Moreover, at the other locations, an increase in blurred image feeling caused by the filtering process can be prevented.

In the example shown in FIG. 8, after extracting the information of the block size of the orthogonal transformation, the information of the quantization step size is extracted. However, the present embodiment is not limited to this example, and can be also configured such that, by reversing the order of Step S301 and Step S302, the information of the block size of the orthogonal transformation is extracted after extracting the information of the quantization step size.

Moreover, the extraction of the information of the quantization step size can be performed by determination of the orthogonal transformation size at Step S303 subsequent to Step S303 when the block size of the orthogonal transformation is equal to or more than a predetermined value.

Further, when there are equal to or more than three types of values of the quantization step size used during the encoding, the strength of a filter or the like can be divided into three or more stages by branching the process at Step S304 into equal to or more than three.

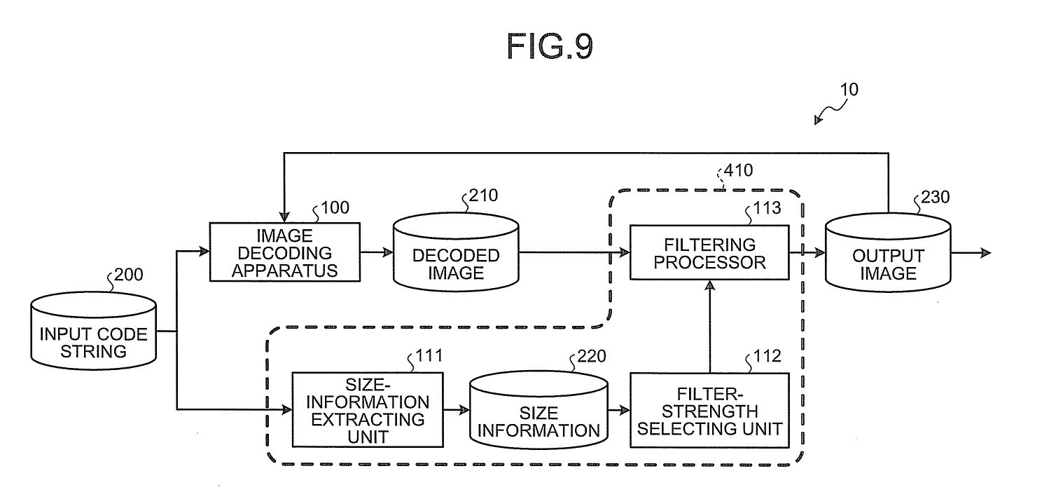

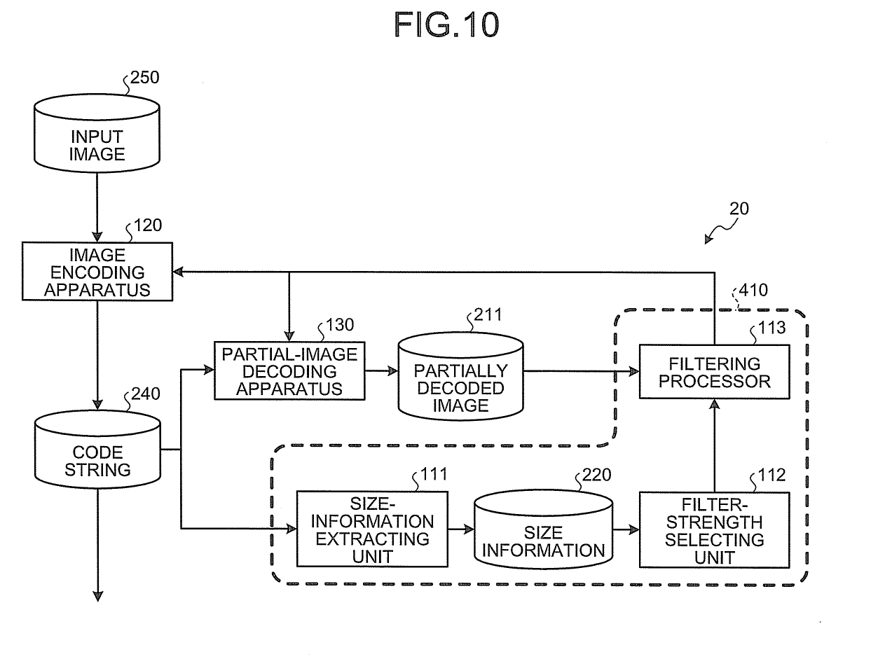

FIG. 9 and FIG. 10 are schematic diagrams for respectively explaining an example in which the filter apparatus of the present embodiment is used for a loop filter incorporated in a moving image decoding apparatus and a moving image encoding apparatus.

A moving image decoding apparatus 10 of FIG. 9 includes the image decoding apparatus 100 and the filter apparatus 410. The functions and configuration of the filter apparatus 410 are the same as those of the filter apparatus 410 included in the image processing apparatus 1 of FIG. 1. The output image 230 processed by the filter apparatus 410 is used as a reference image during decoding following images by the image decoding apparatus 100.

Accordingly, the image decoding apparatus 100 can utilize the reference image having only a small amount of encoding distortion. When an inter-picture predicting process is performed in the moving image encoding process, the less the encoding distortion of the reference image, the less the encoding distortion of a decoded image that refers to the reference image. Thus, the encoding distortion of the whole decoded image can be decreased.

A moving image encoding apparatus 20 of FIG. 10 includes an image encoding apparatus 120, a partial-image decoding apparatus 130, and the filter apparatus 410. The functions and configuration of the filter apparatus 410 are the same as those of the filter apparatus 410 included in the image processing apparatus 1 of FIG. 1.

The image encoding apparatus 120 performs an image encoding process by an inter-frame compressing process on an input image 250, and outputs a code string 240. The partial-image decoding apparatus 130 decodes the code string 240 and outputs a partially decoded image 211. The image encoding apparatus 120 further performs an inter-picture predicting process in which the partially decoded image 211 that is filtering-processed by the filter apparatus 410 is used as the reference image, and outputs the code string 240.

In the example shown in FIG. 10, the partial-image decoding apparatus 130, which decodes the code string 240, can output the partially decoded image 211 by performing an inverse quantizing process and an inverse orthogonal transformation on a value which is obtained before the code string is formed and on which the orthogonal transformation and the quantizing process are performed.

Accordingly, in the image encoding apparatus 120, the same reference image as that of the partial-image decoding apparatus 130 can be used, and thus the effective encoding can be performed. More particularly, for example, when performing a motion vector search, the reference image having only a small amount of encoding distortion is used, and thus a more favorable motion vector can be searched and an inter-frame pixel-value difference between the reference image and an image to be encoded can be reduced.

The “size-information extracting unit”, “filter-strength selecting unit”, and “filtering processor” in the present embodiment respectively correspond to “size acquiring unit”, “filter selecting unit”, and “encoding-distortion reducing unit” in the appended claims. Further, the “edge-region detecting unit” and “quantization-step size-information extracting unit” in the present embodiment respectively correspond to “edge detecting unit” and “quantization-step size acquiring unit” in the claims.

The image processing apparatuses according to the present embodiment can be realized by a personal computer (PC) or the like, or by an exclusive hardware circuit. For example, the image processing method according to the present embodiment can be performed by causing a central processing unit (CPU) to use a main memory of a random access memory (RAM) or the like as a work area, according to a program stored in a device such as a read only memory (ROM) or a hard disk device.

The program for causing a computer to perform such processing can be provided to users through a communication network such as the Internet, and the program can be distributed to users by having the program recorded in a computer readable recording medium such as a compact disk ROM (CD-ROM) as a computer program product.

According to the above embodiment, it is possible to perform removal of the distortion that occurs in a decoded image obtained by decoding the encoded moving image data, and to decrease in image change other than the noise removal of the decoded image that occurs during the removal at the same time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a size acquiring unit that acquires a block size of an orthogonal transformation from encoded data of an image compressed by performing the orthogonal transformation and quantization for each block;
a filter selecting unit that selects a filter for each block, the filter reducing an encoding distortion from each block of a decoded image; and
an encoding-distortion reducing unit that reduces an encoding distortion by the filter on all pixels within the block, wherein
the filter selecting unit selects the filter so that a strength of the filter strengthens by increasing of the block size, or selects the filter so that the number of taps of the filter decreases by reduction of the block size.

2. The apparatus according to claim 1, wherein the encoding distortion is a ringing distortion.

3. The apparatus according to claim 1, further comprising an edge detecting unit that detects an edge included in the decoded image, wherein
the encoding-distortion reducing unit does not further perform the encoding distortion reduction on a block that does not include the edge detected.

4. The apparatus according to claim 1, further comprising a quantization-step size acquiring unit that acquires a quantization step size in a quantizing process for each of the block from the encoded data, wherein
the filter selecting unit selects the filter so that the strength of the filter strengthens by increasing of the quantization step size, or selects the filter so that the number of taps of the filter increases by increasing of the quantization step size.

5. A moving image decoding apparatus that decodes encoded data encoded by a compressing process including an inter-picture predicting process, and an orthogonal transformation and a quantizing process performed for each block in which the picture is divided, for moving image data constituted by a plurality of continuous pictures, thereby generating a decoded moving image, the apparatus comprising:
a size acquiring unit that acquires a block size for each of the block in the decoded picture;
a filter selecting unit that selects a filter for each block, the filter reducing an encoding distortion from each block of a decoded image;
an encoding-distortion reducing unit that reduces an encoding-distortion by the filter, on all pixels in the block; and
a decoding unit that decodes, from the encoded data, the picture encoded by the inter-picture predicting process by using, as a reference picture, the picture on which the encoding-distortion is reduced, wherein
the filter selecting unit selects the filter so that a strength of the filter strengthens by increasing of the block size, or selects the filter so that the number of taps of the filter decreases by reduction of the block size.

6. A moving image encoding apparatus that performs, on moving image data constituted by a plurality of continuous pictures, a compressing process including an inter-picture predicting process, and an orthogonal transformation and a quantizing process performed for each block in which the pictures are divided, thereby generating encoded data, the apparatus comprising:
a partial-image decoding unit that decodes a partial image by performing an inverse quantizing process and an inverse orthogonal transformation on a picture on which the orthogonal transformation and the quantizing process are performed;
a size acquiring unit that acquires a block size for each block in the partial image decoded;
a filter selecting unit that selects a filter for each block, the filter reducing an encoding distortion from each block of a decoded image; and
an encoding-distortion reducing unit that reduces an encoding-distortion by the filter, on all pixels in the block, wherein
the partial-image decoding unit further uses, as a reference image, a partial image on which the encoding-distortion is reduced, thereby decoding the partial image of the picture on which the inter-picture predicting process is performed,
the filter selecting unit selects the filter so that a strength of the filter strengthens by increasing of the block size, or selects the filter so that the number of taps of the filter decreases by reduction of the block size.
